(19) United States
(12) Patent Application Publication
(10) Pub. No.: US 2014/0139944 A1
(43) Pub. Date: May 22, 2014

(54) INFORMATION STORAGE USING SERVO PATTERNS

(71) Applicant: Imation Corp., St. Paul, MN (US)

(72) Inventors: Douglas W. Johnson, Stillwater, MN (US); Larold L. Olson, Lindstrom, MN (US)

(21) Appl. No.: 13/679,744

(22) Filed: Nov. 16, 2012

(51) Int. Cl. G11B 21/02

(52) U.S. Cl. CPC G11B 21/02
USPC 360/75; 369/43

(57) ABSTRACT

Storage media, systems, and techniques for storing and accessing information in a servo band are described. For example, the distances between adjacent servo patterns written to the servo band may be varied to represent the supplemental information stored in the servo band. Each of the varied distances may be selected to represent physical parameters of the storage medium, servo recording conditions, or data unrelated to the servo patterns, for example. The supplemental information may be recovered from the servo band by demodulating a signal generated from a servo read head. The distances between each servo pattern in the track may be calculated from the time periods detected in the signal between servo marks of subsequent servo patterns. In some examples, a controller may adjust one or more parameters associated with reading or writing servo marks or data marks of the storage media.

### TECHNICAL FIELD

The disclosure relates to data storage media and, more particularly but without limitation, to magnetic storage media recorded with servo patterns.

### BACKGROUND

Data storage media are commonly used for storage and retrieval of data and come in many forms, such as magnetic tape, magnetic disks, optical tape, optical disks, holographic disks or cards, and the like. In magnetic media, data is typically stored as magnetic signals that are magnetically recorded on the medium surface. The data stored on the medium is typically organized along “data tracks,” and transducer heads are positioned relative to the data tracks to read or write data on the tracks. A typical magnetic storage medium, such as magnetic tape, usually includes several data tracks. Optical media, holographic media and other media formats can also make use of data tracks.

During data storage and recovery, the head must locate each data track, and follow the path of the data track accurately along the media surface. In order to facilitate precise positioning of the transducer head relative to the data tracks, servo techniques have been developed. Servo patterns refer to signals or other recorded marks on the medium that are used for tracking purposes. In other words, servo patterns are recorded on the medium to provide reference points relative to the data tracks. A servo read head has a fixed displacement relative to the transducer head that reads the data tracks. The servo read head can read the servo patterns, and a servo controller interprets a detected servo pattern and generates a position error signal (PES). The PES is used to adjust the lateral distance of the servo read head relative to the servo pattern and the transducer head relative to the data tracks so that the transducer head is properly positioned along the data tracks for effective reading and/or writing of data to the data tracks.

With some data storage media, such as magnetic tape, the servo patterns are stored in specialized tracks on the medium, called “servo bands.” Servo bands serve as references for the servo controller. A plurality of servo patterns may be defined in a servo band. Some magnetic media include a plurality of servo bands, with data tracks being located between the servo bands.

One type of servo pattern is a time-based servo pattern. Time-based servo techniques refer to servo techniques that make use of non-parallel servo marks and time variables or distance variables to identify head position. The time offset between the detection of two or more servo marks can be translated into a PES, which defines a lateral distance of the transducer head relative to a data track. For example, given a constant velocity of magnetic tape formed with servo pattern “/ \”, the time between detection of mark “/” and mark “\” becomes longer when the read head is positioned towards the bottom of pattern “/ \” and shorter if the read head positioned towards the top of pattern “/ \”. Given a constant velocity of magnetic media, a defined time period between detected servo signals may correspond to a center of pattern “/ \”. By locating the center of pattern “/ \”, a known distance between the center of the servo band and the data tracks can be identified. Time-based servo patterns are also commonly implemented in magnetic tape media, but may also be useful in other media.

### SUMMARY

In general, this disclosure is directed to servo techniques that utilize servo patterns to facilitate head position relative to data tracks and store supplemental information within the servo band. Supplemental information may be stored in one or more servo bands as varied distances between adjacent servo patterns. The distance between two or more servo patterns may be selected to represent the supplemental information to be stored. Servo patterns may thus be written to a servo band of a storage medium (e.g., a magnetic data storage tape) at various distances from previous servo patterns. The variation in distances between servo patterns may represent the information stored in the servo band. The stored information is in addition to mark configurations that generate a position error signal.

The supplemental information may be retrieved from the servo band by demodulating a signal generated from the storage medium passing by a servo read head. For example, the system may process the signal to identify one or more marks of a first servo pattern and one or more marks of a second servo pattern adjacent to the first servo pattern. The system may also use the time period or delay between the marks of the respective servo patterns to calculate the distance between the marks of the respective servo patterns. The calculated distances may then be used by the system to define the supplemental information as a data set and or a control signal to control one or more aspects of reading marks from and/or writing marks to the storage media. In this manner, supplemental information stored in the servo band may be used to enhance servo writing or reading and/or data writing or reading.

In one example, the disclosure is directed to a data storage medium that includes a servo band, one or more data tracks, a first servo pattern within the servo band and comprising a first set of servo marks, and a second servo pattern within the servo band and comprising a second set of servo marks, wherein a distance between one of the first set of servo marks and one of the second set of servo marks represents at least a portion of information stored in the servo band.

In another example, the disclosure is directed to a method that includes receiving a signal from a servo read head, wherein the signal is generated by a servo band of a data storage medium passing by the servo read head, identifying, from the signal, one or more first servo marks of a first servo pattern in the servo band, identifying, from the signal, one or more second servo marks of a second servo pattern in the servo band, determining, by a processor, a time period between the identified one or more first servo marks and the identified one or more second servo marks, and calculating, by the processor and based on the determined time period, a distance between the one or more first servo marks and the one or more second servo marks, wherein the distance is representative of at least a portion of information stored in the servo band.

In another example, the disclosure is directed to a system that includes a servo read head configured generate a signal from a servo band of a data storage medium passing by the servo read head and a control module. The control module is configured to receive the signal from the servo read head, identify, from the signal, one or more first servo marks of a first servo pattern in the servo band, identify, from the signal, one or more second servo marks of a second servo pattern in the servo band, determine a time period between the identified one or more first servo marks and the identified one or more second servo marks, and calculate, based on the determined time period, a distance between the one or more first servo marks and the one or more second servo marks, wherein the distance is representative of at least a portion of information stored in the servo band.

The details of several examples are set forth in the accompanying drawings and the description below. Other features, objects, and advantages of the disclosure will be apparent from the description and drawings, and from the claims.

### BRIEF DESCRIPTION OF DRAWINGS

FIG. 1A is a block diagram illustrating an exemplary servo writing system configured to pre-record servo patterns on magnetic data storage tape.

FIG. 1B is a block diagram illustrating an exemplary data recording system configured to read servo patterns, obtain supplemental information from servo bands, and record data to the magnetic data storage tape of FIG. 1A.

FIGS. 2A and 2B are conceptual diagrams illustrating example sensors and write elements of the servo head module of FIG. 1A.

FIG. 3 is a conceptual view of a magnetic data storage tape that includes a series of servo patterns recorded in servo bands to store supplemental information.

FIG. 4 is a conceptual diagram of example servo patterns separated by various distances to store supplemental information in a servo band.

FIG. 5 is a conceptual view of an example magnetic data storage tape with alternating servo bands and data tracks.

FIG. 6 is a flow diagram illustrating an example process for detecting a servo writing parameter and writing servo patterns with varied inter-pattern distances to store information representative of the detected parameter.

FIG. 7 is a flow diagram illustrating an example process for demodulating a signal from servo patterns to recover information stored in the servo band and control a servo read setting based on the information.

### DETAILED DESCRIPTION

This disclosure is generally related to magnetic data storage media, techniques, and systems for storing supplemental information in a servo band of linear magnetic storage media. Servo patterns are typically written to a servo band, or servo track, of a magnetic data storage medium (e.g., a magnetic storage tape or magnetic storage disk) such that a position error signal (PES) can be obtained from the storage medium to facilitate the positioning of the data read head to one or more data tracks on the storage medium. However, as servo and data track pitches are narrowed to increase track and data density on storage media, precise data head positioning becomes increasingly difficult. For example, data tracks may be as narrow as one micrometer or smaller in some applications. In addition, the area of the storage medium occupied by servo bands is not used to store data and increase the data density of the storage medium.

As described herein, placement of servo patterns within a servo band may be used to store information. This information may be referred to as supplemental information such that the stored information supplements, or is in addition to, PES encoded information in the servo band and data stored in a data track. In some examples, the supplemental information may be represented or encoded by varied distances between adjacent servo patterns in the servo band. In other words, the distance between some or all of the servo patterns may be selected to represent the supplemental information stored in the servo band when the servo patterns are written. The varied distances may be selected from two distances to represent digital data or three or more distances to represent analog data.

Each of the servo patterns may include two or more servo marks oriented in the servo band that, when read by a servo read head, a PES is generated to position the data head with respect to one or more data tracks. In other words, the PES used to position the data head may only be dependent upon the spacing of servo marks within each servo pattern. Since the PES can be determined from two or more servo marks within each of the servo patterns, changes in distance between servo patterns will not affect the PES. This unaffected PES reading may also allow servo read heads not configured to extract the supplemental information to still use the PES to position the data read head to the data tracks of the storage media.

The supplemental information may be extracted from the servo band by demodulating a signal generated by the servo patterns of the servo band passing by a servo read head. One or more representative marks from respective servo patterns may be identified to calculate the distance between adjacent servo patterns in the servo band and extract the supplemental information. For example, the system may process the signal from servo read head to identify one or more marks of a first servo pattern and one or more marks of a second servo pattern adjacent to the first servo pattern. The system may also use the time period or delay between the marks of the respective servo patterns to calculate the distance between the marks of the respective servo patterns. The calculated distances may then be used by the system to define the supplemental information as a data set.

The supplemental information, or the data set from one or more servo bands, may be used to enhance one or more features of the magnetic data storage media system. For example, the supplemental information may be stored and later used to control one or more parameters of the servo read system to improve the accuracy of the PES signal. In another example, the supplemental information may be used to control one or more parameters of the data read and/or write system to improve the recorded data and/or improve the ability to read data from the data tracks. The supplemental information may even be used during a first servo writing phase to identify servo mark or medium deficiencies and re-write the servo marks. Alternatively, the supplemental information may be transmitted with the data from the data tracks to another computing device. In this manner, supplemental information may be additional data stored on the magnetic data storage medium without occupying any of the data track recordable space. Storing the supplemental information in servo bands may thus increase the data density of storage media.

The magnetic data storage media will be generally described herein as magnetic data storage tape. The storage tape may be a flexible medium stored on one or more spools and moved in a linear manner relative to the housing enclosing the storage tape. However, any other magnetic data storage medium (e.g., a hard disk drive) or non-magnetic storage medium that utilizes data tracks and servo bands to position data read/write heads may utilize the techniques described herein. Other linear “tape” media may also benefit from the techniques of this disclosure, including optical tape, magneto-optic tape, holographic tape or other tape-based storage media.

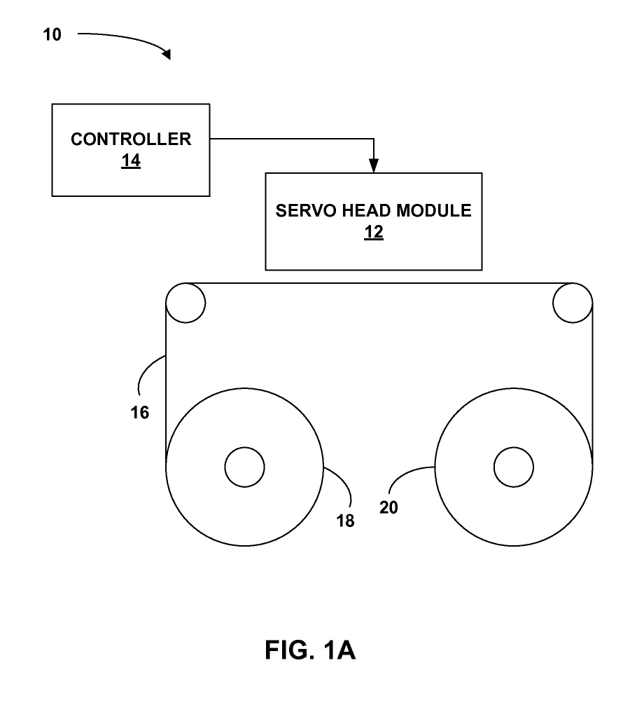

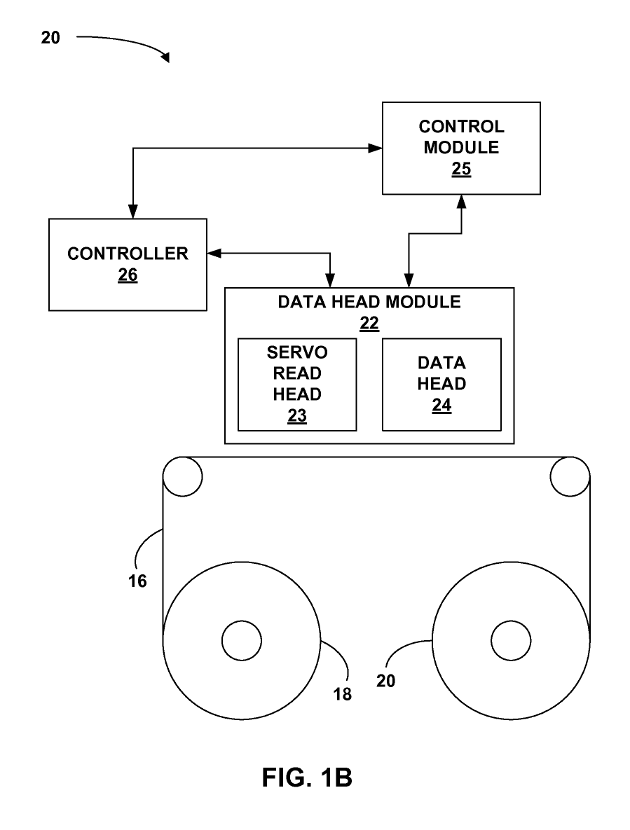

FIG. 1A is a block diagram illustrating an exemplary servo writing system 10 configured to pre-record servo patterns on magnetic tape 16. System 10 includes servo head module 12, servo controller 14, and magnetic tape 16 spooled on spools 18 and 20. Servo head module 12 may contain one or more servo heads to write servo patterns on magnetic tape 16. Controller 14 may be configured to control the magnetic fields applied by the one or more servo heads of servo head module 12. Magnetic tape 16 feeds from spool 18 to spool 20, for example, passing in close proximity to servo head module 12. For example, magnetic tape 16 may contact the one or more servo heads of servo head module 12 during servo recording.

Servo head module 12 may include electromagnetic elements that generate magnetic fields. Each servo write head (not shown in FIG. 1A) may include one or more electromagnetic elements. In one embodiment, controller 14 may be configured to cause a first servo head to write substantially over the full servo band associated with magnetic tape 16. In other words, the first servo head may be used to create a bias over the full servo band and prepare the servo band for servo marks to be written. Then, controller 14 may be configured to cause at least one additional servo head within servo head module 12 to selectively erase servo marks within the prerecorded servo band.

In a different example, the servo band portion of magnetic tape 16 may be randomly magnetized instead of substantially written to create a bias. Controller 14 may cause at least one servo head within servo head module 12 to write servo marks within a randomly magnetized servo band of magnetic tape 16.

A servo head on servo head module 12 may include more than one write element. Each write element may be independently operated to write servo marks on magnetic tape 16. For example, a one write element may be used to provide a servo pattern in one servo band with at least three servo marks configured to allow correction of error in position error signal (PES) calculation due to read velocity tape speed variation. Additional write elements may also be used to write servo patterns having at least three servo marks in respective additional servo bands. Multiple write elements may write substantially identical servo marks to the respective servo bands as the magnetic tape 16 passes the write elements. In other examples, one or more write elements may write different servo marks specific to a respective servo band.

System 10 is generally described with respect to a servo write (or record) system. However, a similar system may be used to read servo patterns and write and/or read data from the data tracks of magnetic tape 16. For example, a servo read head may be used to read the servo marks of servo patterns present in the one or more servo bands of magnetic tape 16. The servo read head may generate, based on the servo patterns in the servo band, a PES used to position one or more data heads to their respective data tracks of magnetic tape 16. Data read heads may then read data from respective data tracks and/or data write heads may write data to respective data tracks. In this manner, a servo write system such as system 10 may be used to write servo patterns to magnetic tape 16 and a data recording system may be used to read the servo patterns and write and record data to magnetic tape 16. In some examples, a single system may include both servo writing and data recording components.

As generally described herein, system 10 may be used to encode supplemental information into one or more servo bands of magnetic tape 16. Servo head module 12 may store the supplemental information into the servo bands by varying the distance between servo patterns in the servo band. In other words, the linear distance between two servo patterns may be varied to represent the supplemental information. This varied distance between servo patterns (and the servo marks within each servo pattern) may generate a signal that is demodulated to recover the supplemental information represented by the varied distances. The supplemental information may be used to control one or more parameters associated with reading or writing with magnetic tape 16. Alternatively, the supplemental information may be used to store any type of data in the servo band.

In one example, magnetic tape 16 may include a servo band, one or more data tracks, a first servo pattern within the servo band and including a first set of servo marks and a second servo pattern within the servo band and including a second set of servo marks. Each data track may include additional servo patterns as well. The distance between one of the first set of servo marks and one of the second set of servo marks may be selected to represent at least a portion of information (e.g., supplemental information) stored in the servo band. This example may be extrapolated to any number of servo patterns within a servo band. For example, the servo band may include a series of three or more servo patterns, wherein the series of servo patterns includes the first and second servo patterns. At least some, or even all, of the distances between servo marks of adjacent servo patterns in the series may be varied to encode the information in the servo band. Magnetic tape 16 may be referred to as a data storage medium

In some examples, the supplemental information may be stored as digital data within the servo band. The distances between adjacent servo patterns may be selected from two possible distances to encode the digital data. In one example, a number of digital bits defined by successive servo patterns may collectively define a digital word that can be encoded to represent relatively complex information. In other examples, the supplemental information may be stored as analog data where the distances are selected from three or more possible distances. As some examples, any respective distance between successive servo patterns may define single-bit or multi-bit information. In the later case, a number of different distances between successive servo patterns may be defined and selected for conveying different information. In one example, the number of different distances may be preset such that a parameter or value corresponds to one of the different distances.

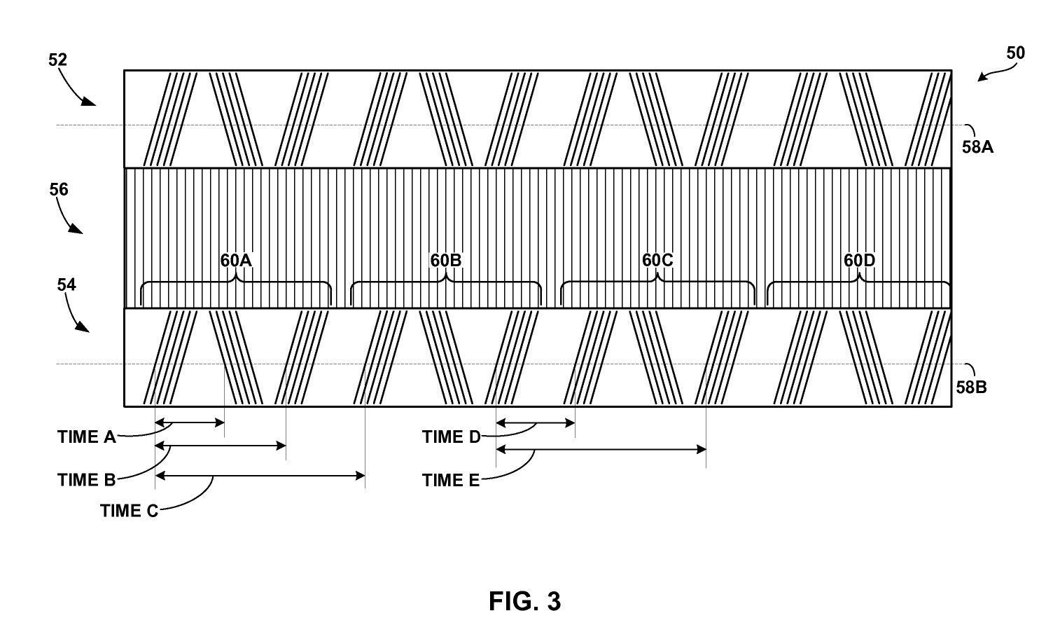

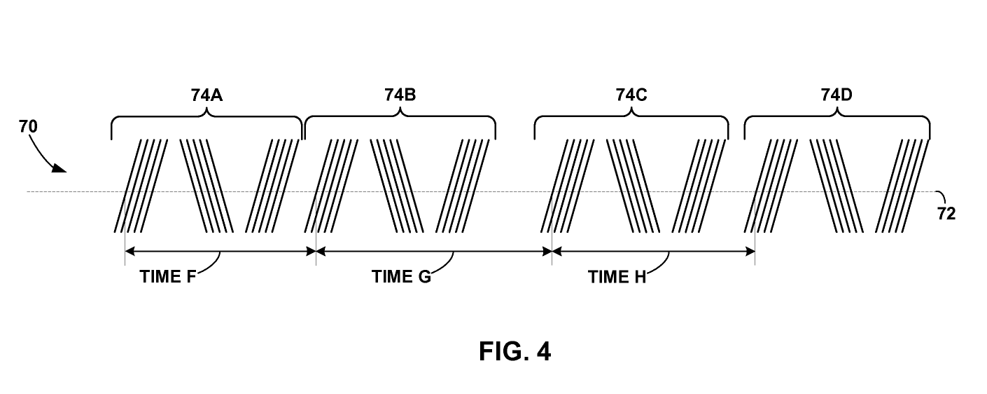

Each of the servo patterns written to the servo band may contain a plurality of servo marks. The servo marks of each servo pattern may be oriented and positioned in such a way that the PES may be obtained from the servo marks of each servo pattern. In this manner, the PES may not be dependent upon the spacing, or distance, between adjacent servo patterns. In one example, the set of servo marks for each servo pattern may form an “N” pattern. The “N” pattern may include three different subsets of servo marks. The first one or more marks may have a non-orthogonal orientation with respect to the servo band. The second one or more marks may be down-medium and non-parallel to the one or more first marks. The third one or more marks may be down-medium to the one or more second marks and substantially parallel to the one or more first marks. In other words, each of the three subsets of servo marks of the “N” pattern may form one of the straight lines of the “N” shape. Examiner “N” patterns are illustrated in the examples of FIGS. 3 and 4.

The distance between each adjacent servo pattern may be determined using a variety of different marks from each servo pattern. In one example, the distance may be determined from the first subset of marks in the first servo pattern and the first subset of marks in the second servo pattern. In this example, the distance may include the distance covered by the first servo pattern. In another example, the distance may be determined from the third subset of marks (e.g., the last subset of marks) in the first servo pattern to the third subset of marks in the second servo pattern. In this example, the distance may include the distance covered by the second servo pattern. In an alternative example, the distance may be determined from the third subset of marks in the first servo pattern to the first subset of marks in the second servo pattern. In this example, the distance may be representative of the gap or distance between any marks of the adjacent first and second servo patterns (e.g., a distance in the servo band that does not generally include subsets of marks from the servo patterns).

Servo patterns other than “N” patterns may be used in other examples. These servo patterns may be arranged such that the PES calculation can be made from each servo pattern instead of requiring the distance between adjacent servo patterns as part of the calculation. However, in alternative examples, the distance between a set of servo patterns may be fixed for PES purposes while the distance between different sets of servo patterns may be varied to store the supplemental information.

Each of the servo patterns written to magnetic tape 16 during the servo writing process may be configured to provide a PES. The PES is used by data recording drive to facilitate data head positioning relative to one or more data tracks. As the servo read head passes by the servo patterns, the PES will change according to the lateral position of the servo read head relative to the servo pattern. A controller may demodulate the PES to calculate a needed change in position of the data heads, if any change is needed. The supplemental information described herein is not a component of the position error signal, however, one or more servo marks used to generate the PES may also be used to define the distance between servo patterns that represent the at least a portion of the supplemental information.

Many different types of supplemental information may be stored in the servo band and represented by varied distances between servo patterns. For example, the information may include information indicative of one or more physical parameters of magnetic tape 16. The physical parameters may include the width of magnetic tape 16 (or changes in the tape width over the length of the tape), a tape friction, a tape roughness, and/or a magnetic remanence and thickness value. These physical parameters may be used to control a parameter of reading or writing to an appropriate value to optimize the reading and/or writing of servo patterns and/or data for magnetic tape 16.

In another example, the information may include information indicative of one or more servo recording conditions of the data storage medium during a period prior to the recording of the first and second servo patterns. The servo recording system (e.g., system 10), may include a sensor that detects one or more recording parameters during servo writing and subsequently store an indication of the one or more recording parameters as the supplemental information in the servo band. In this manner, the period of the servo recording condition may necessarily occur prior to the indicative information being stored in the servo band. Example servo recording conditions may include the speed of magnetic tape 16 during recording, a concavity of magnetic tape 16, the tension of magnetic tape 16, a height of the servo write head above magnetic tape 16, or any other detectable or known parameters. These servo recording conditions may be used to control any of these conditions when reading servo patterns and/or correct any errors in the PES calculation.

Magnetic tape 16 may include one or more servo bands and one or more data tracks. The number of servo bands may equal the number of data tracks. In other examples, the number of servo bands may be lesser or greater than the number of data tracks. In one example, magnetic tape 16 may include one more servo band than the number of data tracks. In further examples, each of the one or more data tracks may be located between respective servo bands (e.g., servo bands and data tracks may alternate across the width of magnetic tape 16).

Servo patterns may, in some examples, be written to magnetic tape 16 to facilitate forward and reverse data recording directions. Since the servo marks of each servo pattern may be oriented to be read in a specific direction, servo pattern orientation for the forward direction of magnetic tape 16 may be opposite of the servo pattern orientation for the reverse direction of magnetic tape 16. In this manner, a first subset of the servo bands may include servo patterns oriented to be read in the forward direction of magnetic tape 16. A second subset of the servo bands, different from the first subset of the servo bands, may include servo patterns oriented to be read in the reverse direction of magnetic tape 16. The forward direction may be opposite the reverse direction. In some examples, the forward subset of servo bands may alternative across the width of magnetic tape 16 with the reverse subset of servo bands. In other examples, the forward and reverse servo bands may be grouped to a respective side of magnetic tape 16 and/or grouped with the respective forward and reverse data tracks.

FIG. 1B is a block diagram illustrating exemplary data recording system 20 configured to read servo patterns, obtain supplemental information from servo bands, and record data to the magnetic tape 16 of FIG. 1A. Data recording system 20 may be configured to record data to the data tracks of magnetic tape 16. Example system 20 includes magnetic tape 16, spools 18 and 20, data head module 22, control module 25, and controller 26. Data head module 22 may include one or more servo read heads 23 and data heads 24. Each of control module 25 and controller 26 may include one or more processors or other hardware and/or software modules configured to perform the functions described herein.

Once the supplemental information has been recorded to magnetic tape 16 using the distance variation between adjacent servo patterns, servo read head 23 may generate a signal indicative of the varying distances. The signal may be transmitted to control module 25. Control module 25 may then demodulate the signal to extract, decode or recover, the supplemental information from the servo band. In this manner, control module 25 may be configured to receive a signal from servo read head 23. Servo read head 23 may generate the signal from one or more servo bands of magnetic tape 16 passing by servo read head 23.

Control module 25 may include one or more processors and/or circuits configured to demodulate the signal from servo read head 23 to extract the supplemental information. Control module 25 may be configured to identify, from the signal, one or more first servo marks of a first servo pattern in the servo band of magnetic tape 16. Control module 25 may also be configured to identify, from the signal, one or more second servo marks of a second servo pattern in the same servo band of magnetic tape 16. This identification may be made by detecting maximum and/or minimums of amplitude within the signal. For example, amplitude maximums may indicate detection of a servo mark.

Control module 25 may then determining a time period between the identified one or more first servo marks and the identified one or more second servo marks. This time period may be dependent upon the distance between each servo mark and the speed at which magnetic tape 16 is passed by servo read head 23. Using the known speed of magnetic tape 16, control module 25 may calculate, based on the determined time period, a distance between the one or more first servo marks and the one or more second servo marks. This calculated distance may be representative of at least a portion of the supplemental information stored in the servo band.

Control module 25 may perform this identification and calculation for each servo pattern. For example, control module 25 may identify, from the signal, one or more servo marks of three or more servo patterns in a series of servo patterns in the servo band. Control module 25 may determine time periods between the identified one or more servo marks of the respective servo patterns in the series of servo patterns and calculate, based on the determined time periods, distances between the one or more servo marks of the respective servo patterns. These distances may be representative of the supplemental servo information. Control module 25 may continuously calculate the distances as the signal is received from servo read head 23. In some examples, the distance determinations may occur in real-time, or as fast as control module 25 can analyze the received signal and produce the distances and/or the supplemental information represented by the distances. This real-time determination may be used for controlling one or more parameters of data recording system 20 using the supplemental information. In other examples, control module 25 may calculate the distances in batches or after the entire signal is received and stored to a memory.

Control module 25 may be configured to control one or more aspects of data recording system 20 based on the supplemental information. For example, control module 25 may control, based on at least a portion of the supplemental information, one or more parameters associated with reading servo patterns from the servo band of magnetic tape 16. For example, control module 25 may adjust a speed of magnetic tape 16, a tension applied to magnetic tape 16, a sensitivity of servo read head 23, a height above and/or lateral position of servo read head 23 relative to magnetic tape 16. In another examples, control module 25 may be configured to control, based on time periods between servo marks identified within each of respective servo patterns, a position of data head 24 (e.g., a data read head and/or a data write head) relative to a data track of magnetic tape 16. Control module 25 may control these parameters may command controller 26 to adjust one or more parameters of data head module 22.

Control module 25 may also be configured to control the position of data head 24 relative to the data tracks of magnetic tape 16. As described herein, the PES calculation may be used to perform this task. In one example, control module 25 may be configured to generate, based on time periods between servo marks identified within each of respective servo patterns, the PES used to facilitate the position of data head 24 relative to one or more data tracks of magnetic tape 16. In some examples, control module 25 may correct the PES using at least a portion of the supplemental information. The PES may be corrected based on sensed physical parameters of magnetic tape 16 during servo writing and/or one or more parameters of the servo recording conditions. Controller 26 may then be configured to control, based on the corrected PES, position of data head 24 relative to the data track of magnetic tape 16.

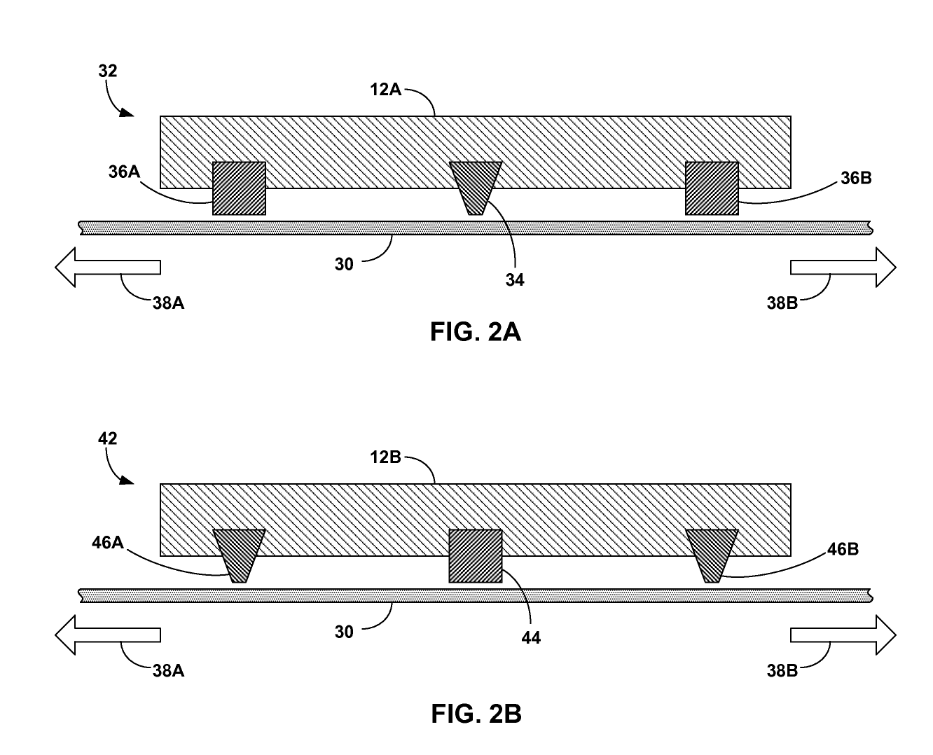

FIGS. 2A and 2B are conceptual diagrams illustrating sensors and write elements of example servo head modules 12A and 12B of servo head module 12 of FIG. 1A. Servo head modules 12A and 12B provide different configurations or servo write elements and sensors for sensing and writing servo patterns in both a forward and reverse direction of magnetic tape 30. Magnetic tape 30 may be an example of magnetic tape 16 of FIG. 1A.

As shown in FIG. 2A, servo writing system 32 includes servo head module 12A configured to be positioned above and in close proximity to the surface of magnetic tape 30. Servo head module 12A includes sensors 36A and 36B positioned on opposing sides of servo write element 34. Servo write element 34 may be configured to write servo marks, and servo patterns, to one or more servo bands of magnetic tape 30. Each of sensors 36A and 36B may be configured to detect one or more parameters or conditions of magnetic tape 30. For example, sensors 36A and 36B may be optical or magnetic sensors configured to detect the edge (e.g., a tape width) of magnetic tape 30.

Multiple sensors 36A and 36B may be provided to support sensing of magnetic tape 30 prior to servo writing element 34 in a respective forward and reverse direction. For example, when magnetic tape 30 moves the direction of arrow 38B (e.g., the forward direction), sensor 36A is positioned to detect an aspect of a region of magnetic tape 30 prior to the region reaching servo write element 34. In this manner, servo write element 34 may be controlled to vary the distance between servo patterns to store the sensed parameter from sensor 36A as supplemental information in the servo band. Similarly, sensor 36B may be positioned to detect an aspect of a region of magnetic tape 30 prior to the region reaching servo write element 34 when magnetic tape 30 is moved in the direction of arrow 38A (e.g., the reverse direction). Servo writing element 34 may thus use the detected parameter from sensor 36B in the reverse direction to store supplemental information in the servo band of the reverse direction.

Magnetic tape 30 may include multiple servo bands and data tracks to support forward and reverse recordings. For example, servo writing element 34 may write servo marks in a forward orientation within a subset of the servo bands associated with the forward direction (e.g., the tape direction of arrow 38B). Servo writing element 34 may also write servo marks in a reverse orientation within a different subset of the servo bands associated with the reverse direction (e.g., the tape direction of arrow 38A). The forward and reverse servo bands may be associated with respective forward data tracks and reverse data tracks. Therefore, different subsets of servo bands and data tracks may be used for the respective forward and reverse directions of magnetic tape 30.

FIG. 2B illustrates an alternative configuration of servo head module 12 of FIG. 1A. System 42 of FIG. 2B provides an example servo head module 12B. Servo head module 12B includes sensor 44 positioned between servo write elements 46A and 46B. In the configuration of servo head module 12B, sensor 44 may detect one or more parameters of magnetic tape 30 when magnetic tape 30 is moving in the direction of arrow 38 B (e.g., the forward direction) and arrow 38A (e.g., the reverse direction). Sensor 44 may be substantially similar to one or both of sensors 36A and 36B of FIG. 2A, and servo write elements 46A and 46B may be substantially similar to servo write element 34 of FIG. 2A.

However, each of servo write elements 46A and 46B may be used to write servo marks for respective directions of magnetic tape 30. For example, servo write element 46B may write servo patterns with distances between each servo pattern in the forward direction according to detected parameters from sensor 44. In addition, servo write element 46A may write servo patterns in the reverse direction separated by distances according to the detected parameters from sensor 44. Although multiple servo write elements 46A and 46B may be used in the example of FIG. 2B, only one sensor 44 may be needed to detect aspects of magnetic tape 30 for both the forward and reverse directions of the tape.

For either servo head module 12A or 12B, controller 14, for example, may be configured to generate timed pulses of magnetic signals to the respective servo write elements 34, 46A, and 46B as magnetic tape 30 passes relative servo head modules 12A or 12B. The timed pulses may be timed according to the respective distances between servo patterns to represent the supplemental information and the known (e.g., controlled or detected) speed of magnetic tape 30. More specifically, controller 14 may apply electrical signals to the respective servo write element via a coil (not shown) in order to generate magnetic fields that orient the magnetic particles of magnetic tape 16 in a particular direction and at specific intervals along the servo track. These orientations of magnetic particles may create each servo mark.

A plurality of servo marks may create each servo pattern. In some examples, each write element (e.g., servo write element 34, 46A, and 46B), may include individual coils arranged to create each servo mark of a single servo pattern. In this manner, the servo marks of each servo pattern may be created substantially simultaneously. Each servo pattern may include servo marks with substantially the same intra-pattern spacing as other servo patterns. Controller 14 may thus vary the timing of electrical pulses sent through the servo write element to vary the distances between each servo pattern and encode the supplemental information in the servo band.

FIG. 3 is a conceptual view of magnetic data storage tape 50 that includes a series of servo patterns 60A, 60B, 60C, and 60D (collectively “servo patterns 60”) recorded in servo bands to store supplemental information. As shown in FIG. 3, data storage tape 50 includes data tracks 56, servo band 52 and servo band 54. Each of servo patterns 60 may include a plurality of servo marks within a single frame. Servo patterns 60A, 60B, and 60C are shown as complete, but servo pattern 60D is not shown completely as a portion of servo pattern 60D extends beyond the portion of data storage tape 50 shown in FIG. 3. Data storage tape 50 may be an example of magnetic tape 16 of FIGS. 1A and 1B and/or magnetic tape 30 of FIGS. 2A and 2B.

As referred herein, a servo pattern includes a plurality, or grouping, of servo marks. At least some of the servo marks within each servo pattern may cause the generation of a position error signal that is used to position a data head over one or more data tracks 56. As shown in FIG. 3, each of servo patterns 60 includes the same number, orientation, and spacing of servo marks. This consistency of servo mark spacing within each servo pattern 60 may contribute to the consistency of the PES between each servo pattern. However, the distances between each of servo pattern 60 may be varied to record the supplemental information within servo bands 52 and 54. This variable spacing or variable positioning of servo patterns 60 may be defined by a controller, such as controller 14 of FIG. 1A, during servo recording. While the servo frames of servo band 52 are not explicitly described in FIG. 3, the techniques described with respect to servo band 54 also apply to servo band 52.

A servo mark may be a continuous shape that can be sensed as a servo read head passes over a media surface of data storage tape 50. Time-based servo marks, such as those in servo patterns 60, are generally lines, but not necessarily straight lines that extend across a data storage media in a manner that would prevent a servo read head from detecting the mark more than once during a single pass; e.g., in other examples, time-based servo marks may have zigzag or curved shapes. With respect to magnetic tape, a servo mark is generally written by a single write gap in a servo head with a single electromagnetic pulse. The term servo marks encompasses servo stripes, which are straight, and also includes curved servo marks and servo marks with other shapes.

A servo pattern includes all the servo marks written at the same time by a single write element. As described herein, the servo marks in a single time-based servo pattern allow calculation of a PES using time measurements between the detection of servo marks within the pattern by a servo read head. Generally, all servo marks within a single servo pattern are written using a single electromagnetic pulse so that any inconsistency in tape speed during the servo writing does not affect the spacing of the servo marks in the pattern.

Each servo pattern may include one or more servo marks in different orientations with respect to the servo band. These different orientations of servo marks may be used to generate the PES for the servo pattern. For example, each of servo patterns 60 include three separate subsets of servo marks in the form of an “N” pattern or marks configured as “/ \ /”. In other examples, marks may be configured as chevrons (e.g., marks configured as “< >” or “<<<< >>>>”) or any other shapes and repetitions of shapes. The first servo marks (shown as the left-most marks of servo pattern 60A) may have a non-orthogonal orientation with respect to servo band 54. This non-orthogonal orientation may be described as having reverse slant in servo band 54. The second servo marks may be down-tape and non-parallel to the one or more first marks. The second servo marks may be described as having a forward slant in servo band 54. The third servo marks may be down-tape to the second marks and substantially parallel to the first marks. The angle created between the first and second marks of servo pattern 60A allows the PES to identify the lateral position of the servo head. The distance between the parallel first and third servo marks provides a consistent time or distance to use in relation to the variable time between the first and second servo marks. The “N” pattern is used herein as an example. However, in other examples of servo patterns, the servo marks within each pattern may create different types of patterns with varying numbers of servo marks.

Although each subset of servo marks are shown as having 5 separate and parallel marks, each subset may have more or less servo marks in each subset. For example, a subset of servo marks may have four, three, two, or as few as one servo mark. In other examples, a subset of servo marks may have six or greater servo marks. The subsets of servo marks within a single servo pattern may all have the same number of servo marks. However, the subsets may have different number of marks in other examples.

In this manner, the servo patterns in servo bands 52 and 54 facilitate positioning of a read head relative to data tracks 56, which reside a known distance from servo bands 52 and 54. The location of a read head along one of head paths 58A and 58B (“paths 58”) is determined by measuring the time between detection of marks forming each servo pattern. As shown in FIG. 3, TIME A represents the time between the detection of the first two servo marks in servo pattern 60A. From this measurement, the position of the read head within servo band 54 can be determined because the distance between these first two servo marks (or between each subset of servo marks) varies as a function of the lateral position of the path of the read head. For example, if head path 58B were closer to data tracks 56, TIME A would be shorter. Likewise, if head path 58B were further from to data tracks 56, TIME A would be greater.

Time B represents the time between the detection of the first and third servo marks in the servo pattern 60A. These first and third servo marks are parallel to each other, and the time between the detection of these two servo marks is independent of the lateral position of the path of the servo read head. However, the measured TIME B is dependent on the tape speed of data storage tape 50 as it passes over the read head. Because TIME B provides a measurement of the tape speed, TIME B can be used to normalize TIME A for the velocity of data storage tape 50 to more accurately determine the position of the read head. In this manner, TIME B can be used in a PES calculation that substantially mitigates error resulting from a variation in velocity of data storage tape 50 during detection of the servo patterns. In other embodiments, time measurements between the detection of servo marks in a servo pattern including at least three servo marks may have a more complex relationship, but still allow a PES calculation that substantially mitigates error resulting from a variation in velocity of a data storage tape.

By locating the positions of head paths 58 relative to servo bands 52 and 54, a PES can be generated to identify lateral positioning error of the read head relative to the data track(s). While PES calculations only require only a single servo pattern, data from multiple servo patterns within a servo band may be combined to improve accuracy of a PES.

In addition to the PES, times (and resulting distances) between servo marks from adjacent servo patterns may be used to store supplemental information in the servo band. Since the PES calculation is made based on times, or distances, between servo marks within a single servo pattern, the inter-pattern distances (e.g., the distance between different servo patterns) does not influence the PES calculation. Therefore, the distance between servo patterns may be varied to store supplemental information. In other words, the distance between servo patterns may be selected to represent at least a portion of supplemental information.

For example, TIME C represents the time between the detection of the first servo marks of servo pattern 60A and the first servo marks of servo pattern 60B. TIME C may be dependent upon the speed of data storage tape 50, but the known distance of TIME B can be used to calculate the distance of TIME C between the beginnings of servo patterns 60A and 60B. In this manner, TIME C may be used to represent the portion of supplemental information stored by the distance between servo patterns.

In other examples, the distance between servo patterns may be calculated using the detection of different servo marks within servo patterns. For example, TIME D represents the time between the detection of the third servo marks of servo pattern 60B and the first servo marks of servo pattern 60C. In another example, TIME E represents the time between the third servo marks of servo pattern 60B and the third servo marks of servo pattern 60C. Any of TIMES C, D, or E may be used to determine the distance between servo patterns, and supplemental information. In other types of servo patterns, any servo marks within servo patterns may be used to determine the distance between servo patterns.

Although the distances between adjacent, or consecutive, servo patterns may generally be used to encode the supplemental information, the relationships between other servo patterns may be used instead. For example, the distance between every two servo patterns may be varied to represent the supplemental information. The distances between the servo patterns of each pair of servo patterns may be fixed and used as a reference or known distance with which to calculate the varied distances. In other examples, the distances between a set of three or more servo patterns may be used to encode a portion of the supplemental information. In this manner, the distances between servo patterns may be distances between any two or more servo patterns within the servo band, or multiple servo bands, may be used to represent supplemental information.

The supplemental information stored by the varied distances between servo patterns 60, and any other servo patterns of data storage tape 50, may be used for a variety of different purposes. In one example, the supplemental information may be stored as an indication of the tape width as detected by one or more edge sensors. The known tape width may be used for reading and/or writing compensation. In another example, tape edge deviation may be sensed and recorded as the supplemental information. The edge deviation may be used to demark non-uniform or deviating sections of data storage tape 50 before those sections reach a head in a drive. Compensation for such sections may be made by the system.

In another example, the supplemental information may be used to correct one or more PES calculations. For example, the supplemental information may be used to identify any potential parameters of data storage tape 50 or additional parameters that may increase the accuracy of each PES calculation. In some examples, this PES correction may be stored by writing servo patterns to servo band 54 twice. The servo recording system may write servo patterns, and a read head may detect the written servo patterns. Based on the aspects of the detected servo patterns, the servo recording system may identify any correction values that increase the accuracy of the PES calculation and store such values or parameters by re-writing servo patterns in the servo band with distances between servo patterns representing the supplemental information of the PES correction values.

In yet another example, the supplemental information may be used to identify the linear position of a head relative to data storage tape 50. This linear position information may be referred to as LPOS. The supplemental information may thus encode linear position (LPOS) information in accordance with a currently existing tape storage standard format, e.g., an LTO Ultrium format.

As described herein, the supplemental information may be stored within servo bands 52 and/or 54 to represent any type of information. The supplemental information may be stored in some or all of the servo bands of data storage tape 50. In some examples, the supplemental information stored in each servo band is substantially identical. In other words, the distances between servo patterns may be the same in each servo band for the same linear position of data storage tape 50. In other examples, the supplemental information and distances representing such information may be different in at least some or all of the servo bands of data storage tape 50.

FIG. 4 is a conceptual diagram of example servo patterns 74A, 74B, 74C, and 74D (collectively “servo patterns 74”) separated by various distances to store supplemental information in servo band 70. Head path 72 may indicate the path of a servo head over servo patterns 74. Servo patterns 74 may be similar to servo patterns recordable on data storage tape 50 of FIG. 3, for example. Servo patterns 74 are shown at various distances with respect to each other. These changes in distances may be used to encode the supplemental information into servo band 70.

For example, TIME F represents the time between the detection of the first servo mark of servo pattern 74A and the first servo mark of servo pattern 74B. Likewise, TIME G represents the time between the detection of the first servo mark of servo pattern 74B and the first servo mark of servo pattern 74C, and TIME H represents the time between the detection of the first servo mark of servo pattern 74C and the first servo mark of servo pattern 74D. Each of TIMES F, G, and H are different from each other and have been selected to represent, or encode, associated values of a sensed parameter or other known value.

Generally, each of TIMES F, G, and H may be normalized to a known time, such as the time detected between the first and third servo marks of each servo pattern 74. In other examples, TIMES F, G, and H may not need to be normalized. For example, if the distances between each servo pattern 74 represent digital data with only two possible distances (e.g., binary values), the detected times may be compared and directly converted into one of the binary values.

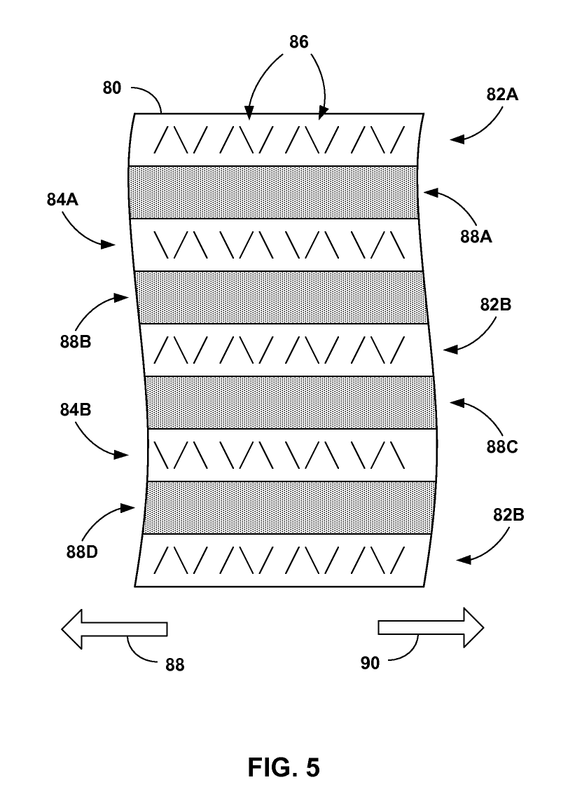

FIG. 5 is a conceptual view of an example magnetic data storage tape 80 with alternating servo bands and data tracks. Data storage tape 80 may be an example of magnetic tape 16 of FIGS. 1A and 1B, magnetic tape 30 of FIGS. 2A and 2B, or data storage tape 50 of FIG. 3. As shown in FIG. 5, data storage tape 80 includes data tracks 88A, 88B, 88C, and 88D (collectively “data tracks 88”), forward servo bands 82A, 82B, and 82C (collectively “forward servo bands 82”), and reverse servo bands 84A and 84B (collectively “reverse servo bands 84”).

Forward servo bands 82 and reverse servo bands 84 may each include a plurality of servo patterns 86. However, the orientation of the servo patterns within each servo band may be dependent upon the direction (e.g., forward or reverse) in which the servo patterns have been recorded. Forward servo bands 82 may be used when data storage tape 80 moves in the direction of arrow 88, and reverse servo bands 84 may be used when data storage tape 80 moves in the direction of arrow 90, for example.

Forward servo bands 82 and reverse servo bands 84 may be alternated across the width of data storage tape 80. Data tracks 88 may also alternate between servo bands 82 and 84 across the width of data storage tape 80. In some examples, a subset of data tracks 88 may be associated with forward servo bands 82 and a different subset of data tracks 88 may be associated with reverse servo bands 84. Forward servo bands 82 and reverse servo bands 84 may be distributed across data storage tape 80 to provide servo bands in close proximity to data tracks of each direction of tape 80.

Forward servo bands 82 may be used to generate a PES when data storage tape 80 moves in the direction of arrow 88. Conversely, reverse servo bands 84 may be used to generate a PES when data storage tape 80 moves in the direction of arrow 90. One or more, or all, of servo bands 82 and 84 may store supplemental information in the form of varied distances between servo patterns of each servo band.

Although four data tracks and five servo bands are shown in the example of FIG. 5, fewer or more of servo bands and/or data tracks may be provided in other examples. For example, nine total servo bands may be provided in between eight different data tracks. One more servo band than the number of data tracks may generally be provided. However, any number of servo bands may be provided for any number of data tracks. In other examples, multiple data tracks may be provided without separation by one or more servo bands. The need for forward and reverse specific servo bands may be dependent upon the type of servo patterns used to generate the PES. In alternative examples, servo patterns may be direction indifferent such that a servo band can be used for positioning the data head in either the forward or reverse direction.

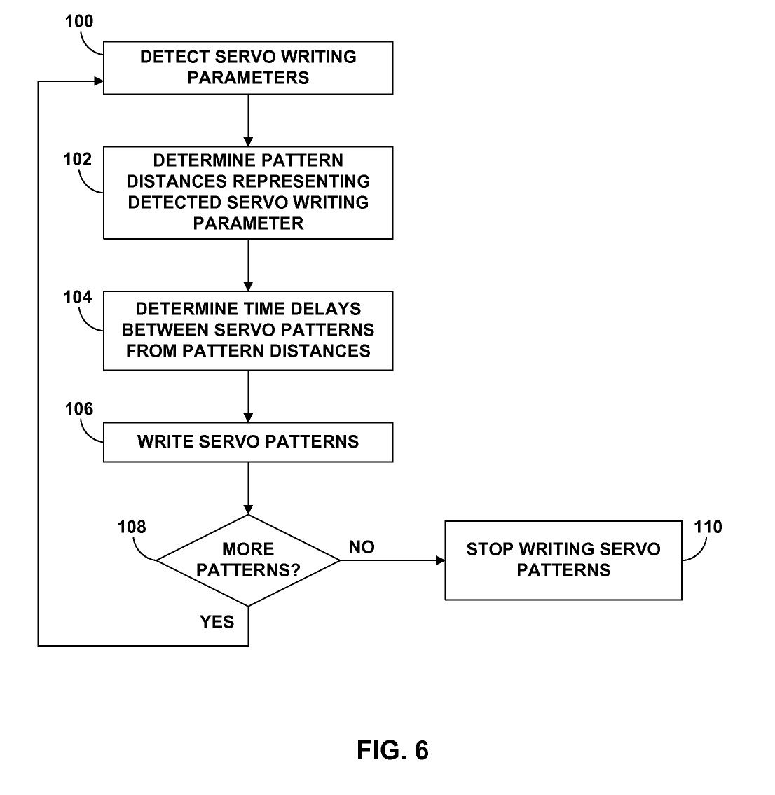

FIG. 6 is a flow diagram illustrating an example process for detecting a servo writing parameter and writing servo patterns with varied inter-pattern distances to store information representative of the detected parameter. For illustration purposes, the techniques shown in FIG. 6 are described with reference to servo recording system 10 and magnetic data storage tape 16 of FIG. 1A.

System 10 may pass magnetic tape 16 near servo read module 12. A sensor of servo read module 12 (e.g., sensor 36A of FIG. 2A), may detect a servo writing parameter (100). For example, the servo writing parameter may be a width of tape 16 or a roughness of tape 16. Controller 14 may determine the inter-pattern distances (e.g., the distances between adjacent servo patterns) that represent the detected servo writing parameter (102). In other words, the servo writing parameter values may be the supplemental information stored in the servo band as varied distances between servo patterns. Controller 14 may also determine the time delays between each of the servo patterns from the pattern distances and the speed of magnetic tape 16 (104). In this manner, controller 14 may determine multiple time delays between multiple servo patterns. However, controller 14 may determine one time delay between two servo patterns in other examples in which the one time delay represents the detected servo writing parameter.

Servo write module 12 then writes the servo patterns to a servo band of magnetic tape 16 according to the determined time delays between each servo pattern (106). The servo patterns may each be written by application of an electrical pulse to a servo write head of servo write module 12 by controller 14. If additional servo patterns are to be written to the servo track of magnetic tape 16 (e.g., to represent additional servo pattern parameters) (“YES” branch of block 108), system 10 may continue to detect additional servo writing parameters (100). If controller 14 determines that no more servo patterns are to be written (“NO” branch of block 108), controller 14 may stop system 10 from writing any additional servo patterns (110).

The process of FIG. 6 may be used to write servo patterns in one or more servo bands of magnetic tape 16 and store supplemental information in the servo bands. In other examples, the supplemental information may not be detected servo writing parameters. Instead, the parameters may be received from known values used to record the servo values, such as tape speed or the linear position of the magnetic tape. In some examples, the supplemental information may be data not associated with the recording or reading of servo patterns. As described herein, the supplemental information may be any type of information to be stored in a servo band that is not used for directly calculating the PES.

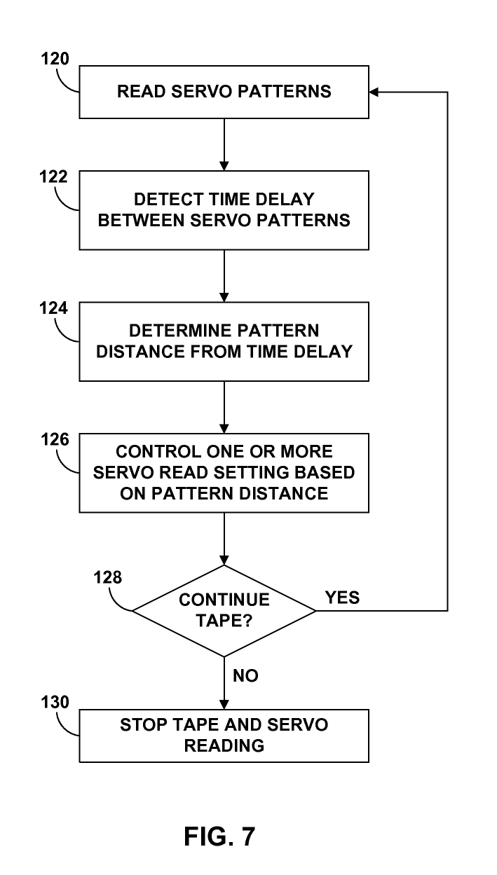

FIG. 7 is a flow diagram illustrating an example process for demodulating a signal from servo patterns to recover information stored in the servo band and control a servo read setting based on the information. For illustration purposes, the techniques shown in FIG. 7 are described with reference to system 20 and magnetic data storage tape 16 of FIG. 1B. The process of FIG. 7 may occur after the servo patterns have been written to magnetic tape 16 according to a process in FIG. 6, for example.

As system 20 moves magnetic tape 16 near servo read head 23, servo read head 23 may read servo patterns in one or more servo band of magnetic tape 16 (120). Reading servo patterns may include generating a signal from the servo marks in each of the servo patterns. The signal may then be sent to control module 25 to allow control module 25 to detect the time delay between servo patterns (122). For example, control module 25 may identify the time delay between the first servo marks of respective servo patterns. Control module 25 may then determine the pattern distance between each servo pattern from the time delay (124). The pattern distance may be determined from the time delay, which varies as a function of the recorded supplemental information, and the detected time delay between a known distance (e.g., the distance between the first and third servo marks of an “N” servo pattern.

Control module 25 may then interpret the varying inter-pattern distances as the supplemental information. Control module 25 may control one or more servo read settings, or parameters, based on the distances (e.g., the supplemental information) (126). For example, control module 25 may correct the PES calculations and command controller 26 to position data head 24. In another example, control module 25 may command controller 26 to change the speed of magnetic tape 16, adjust the tension on magnetic tape 16, or adjust the height of servo read head 23 and/or data head 24 above magnetic tape 16. If system 20 is to continue reading and/or writing from tape 16 (“YES” branch of block 128), servo read head 23 may continue to read servo patterns (120). If system 20 is not to continue reading or writing to magnetic tape 16, system 20 may stop tape 16 and stop servo reading (130).

Although the supplemental information is used to control a servo read parameter in FIG. 7, the supplemental information may be used in other capacities. For example, the supplemental information may be used to know the linear position of data head module 22 with respect to the length of magnetic tape 16. In other examples, the supplemental information may be data unrelated to the writing or reading of servo marks and/or data and transmitted to another device in communication with control module 25.

Various examples have been described. Nevertheless, various modifications may be made without departing from the scope of this disclosure. For example, in some examples, supplemental information may be encoded as varying distances between any number of servo patterns or even between servo patterns with one or more intervening servo pattern within the servo band. Additionally, the supplemental information may be any type of information related or un-related to the operation of a servo recording system and/or data recording system. These and other examples are within the scope of the following claims.

1. A data storage medium comprising:
a servo band and at least one data track adjacent to the servo band;
a first set of servo patterns within the servo band and comprised of at least two servo patterns, each servo pattern in the first set of servo patterns comprising a same number and orientation of a plurality of servo marks as the other servo patterns of the first set of servo patterns; and
a second set of servo patterns within the servo band and comprised of at least two servo patterns, each servo pattern in the second set of servo patterns comprising a same number and orientation of a plurality of servo marks as the other servo patterns of the second set of servo patterns, wherein a leading servo mark of the second set of servo patterns follows a last servo mark of the first set of servo patterns;
wherein a first distance between a servo pattern of the first set of servo patterns and a corresponding servo pattern of the second set of servo patterns represents at least a portion of supplemental information stored in the servo band separate from information relating to a position error signal (PES) that is based on the servo patterns within the servo band.

2. The data storage medium of claim 1, further comprising a a third set of servo patterns within the servo band and comprised of at least two servo patterns, each servo pattern in the third set of servo patterns comprising a same number and orientation of a plurality of servo marks as the other servo patterns of the third set of servo patterns, wherein a second distance between the corresponding servo pattern of the second set of servo patterns and a corresponding servo pattern of the third set of servo patterns is different than the first distance so as to encode supplemental information in the servo band.

3. The data storage medium of claim 2, wherein the first and second distances are selected to represent digital data.

4. The data storage medium of claim 2, wherein the first and second distances are selected to represent analog data.

5. The data storage medium of claim 1, wherein the plurality of servo marks of each servo pattern in the first and second sets of servo patterns form an “N” pattern, wherein the N pattern comprises a first mark with a non-orthogonal orientation with respect to the servo band, a second mark down-medium and non-parallel to the first mark, and a third mark down-medium to the second mark and substantially parallel to the first mark.

6. (canceled)

7. The data storage medium of claim 1, wherein the supplemental information comprises information indicative of a physical parameter of the data storage medium.

8. The data storage medium of claim 1, wherein the supplemental information comprises information indicative of a servo recording condition of the data storage medium during a period prior to the recording of each of the servo patterns.

9. (canceled)

10. The data storage medium of claim 1, further comprising a plurality of servo bands that comprise the servo band, wherein:
a first subset of the plurality of servo bands comprise servo patterns oriented to be read in a first longitudinal direction of the data storage medium; and
a second subset of the plurality of servo bands comprise servo patterns oriented to be read in a second longitudinal direction of the data storage medium opposite the first direction.

11. The data storage medium of claim 1, wherein the data storage medium comprises a magnetic data storage tape.

12. A method comprising:
receiving a signal from a servo read head, wherein the signal is generated by a servo band of a data storage medium passing by the servo read head;
identifying, from the signal, a first set of servo patterns, within the servo band, comprised of at least two servo patterns, each servo pattern in the first set of servo patterns comprising a same number and orientation of a plurality of servo marks as the other servo patterns of the first set of servo patterns;
identifying, from the signal, a second set of servo patterns, within the servo band, comprised of at least two servo patterns, each servo pattern in the second set of servo patterns comprising a same number and orientation of a plurality of servo marks as the other servo patterns of the second set of servo patterns, wherein a leading servo mark of the second set of servo patterns follows a last servo mark of the first set of servo patterns;
determining, by a processor, a first time period between a selected servo pattern of the first set of servo patterns and a corresponding servo pattern of the second set of servo patterns; and
calculating, by the processor and based on the determined first time period, a first distance between the selected servo pattern of the first set of servo patterns and the corresponding servo pattern of the second set of servo patterns, wherein the first distance is representative of at least a portion of supplemental information stored in the servo band separate from information relating to a position error signal (PES) that is based on the servo patterns within the servo band.

13. The method of claim 12, further comprising:
identifying, from the signal, a third set of servo patterns, within the servo band, comprised of at least two servo patterns, each servo pattern in the third set of servo patterns comprising a same number and orientation of a plurality of servo marks as the other servo patterns of the third set of servo patterns;
determining, by the processor, a second time period between the corresponding servo pattern of the second set of servo patterns and a corresponding servo pattern of the third set of servo patterns; and
calculating, by the processor and based on the determined second time period, a second distance between the corresponding servo pattern of the second set of servo patterns and the corresponding servo pattern of the third set of servo patterns, wherein the second distance is different than the first distance so as to encode supplemental information in the servo band.

14. The method of claim 13, wherein the first and second distances are representative of one of digital data or analog data.

15. The method of claim 12, further comprising:
controlling, based on time periods between two or more servo marks identified within each of the first and second sets of servo patterns, a position of a data read head relative to a data track of the data storage medium; and
controlling, based on the at least a portion of supplemental information, a parameter associated with reading servo patterns from the servo band of the data storage medium.

16. The method of claim 15, wherein the parameter at least partially defines one of a speed of the data storage medium, a tension applied to the data storage medium, and a height of the servo read head above the data storage medium.

17. (canceled)

18. A system comprising:
a servo read head configured generate a signal from a servo band of a data storage medium passing by the servo read head; and
a control module configured to:
receive the signal from the servo read head;
identify, from the signal, a first set of servo patterns, within the servo band, comprised of at least two servo patterns, each servo pattern in the first set of servo patterns comprising a same number and orientation of a plurality of servo marks as the other servo patterns of the first set of servo patterns;
identify, from the signal, a second set of servo patterns, within the servo band, comprised of at least two servo patterns, each servo pattern in the second set of servo patterns comprising a same number and orientation of a plurality of servo marks as the other servo patterns of the second set of servo patterns, wherein a leading servo mark of the second set of servo patterns follows a last servo mark of the first set of servo patterns;
determine a time period between a selected servo pattern of the first set of servo patterns and a corresponding servo pattern of the second set of servo patterns; and
calculate, based on the determined time period, a distance between the selected servo pattern of the first set of servo patterns and the corresponding servo pattern of the second set of servo patterns, wherein the distance is representative of at least a portion of supplemental information stored in the servo band separate from information relating to a position error signal (PES) that is based on the servo patterns within the servo band.

19. The system of claim 18, further comprising a controller and a data read head, wherein the controller is configured to:
control, based on time periods between two or more servo marks identified within each of the first and second sets of servo patterns, a position of the data read head relative to a data track of the data storage medium; and
control, based on the at least a portion of supplemental information, a parameter associated with reading servo patterns from the servo band of the data storage medium.

20. (canceled)
